(19) United States
(12) Patent Application Publication
(10) Pub. No.: US 2007/0168329 A1
(43) Pub. Date: Jul. 19, 2007

(54) Database query system using a statistical model of the database for an approximate query response

(76) Inventors: Michael Haft, Zorneding (DE); Reimar Hofmann, Munchen (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/555,887

(22) PCT Filed: Dec. 17, 2003
(86) PCT No.: PCT/DE03/04175

§ 371 Date: Aug. 21, 2006

(30) Foreign Application Priority Data
May 7, 2003 (DE) 103 20 419.9

(51) Int. Cl. G06F 17/30

(52) U.S. Cl. 707/3

(57) ABSTRACT

The invention relates to a data base query system which is characterized in that once the database query is drawn up, a compressed image of the database to be queried is queried in accordance with the database query. Depending on the result of the query of the compressed image an inspection is made whether the result is sufficient and if the result is not sufficient, the database itself is queried in accordance with the database query.

The invention relates to a database query system and to a method for computer-aided querying of a database.

With increasing networking of computers via a telecommunication network, for example via the internet, and the possibilities, improved thereby, of recording and disseminating information by leading to ever larger available data volumes that are frequently stored in assembled fashion in databases.

Almost every operation in a company, every contact with a customer, every order or delivery of a product or else the fabrication of a product usually proceed nowadays with electronic support. Computers and various storage media can be used to log in detail, and store in a database, every operation in a company and/or in the course of a product manufacturing method or also every action or characteristic of a customer.

It is known to acquire such data systematically, for example in the framework of so-called customer relationship management systems (CRM systems) or supply chain management systems.

The value of the recorded and manually input or acquired data is considerable for many companies. Consequently, many companies are striving to convert their data, for example data relating to customers of the company, into knowledge, for example into “knowledge about customers”.

The analysis and evaluation of large data volumes in one or more databases can be performed with the aid of different software tools. Various technologies, known under the designation of online analytical processing (OLAP), aim at determining information from databases for analytical purposes.

A simple querying possibility is offered by the use of database queries known per se, for example formulated in a database query language, preferably in Standard Query Language (SQL).

It is known within the scope of relational online analytical processing (ROLAP) to determine data from a database on the basis of a relational scheme of the original database in accordance with ODBC (open database connectivity) and by using SQL queries.

A technology in which many aggregated items of information are precalculated and stored on a server in a multidimensional cube is denoted as multidimensional online analytical processing (MOLAP). In the event of an analytical request to the database, in accordance with MOLAP the desired information can either be read out directly from the cube or be calculated relatively quickly from a few aggregates to be found there. Because of the plentitude of possible aggregates, MOLAP cubes are very severely limited with regard to the number of dimensions that can be taken into account during MOLAP. The multidimensional cubes can be very large, for which reason there is a need for a very powerful computer as server computer in order to carry out the database queries. Furthermore, even a very powerful server computer can frequently provide insufficient computing power given a multiplicity of requests arriving simultaneously from a number of users.

Many OLAP systems provide an open interface—Microsoft, for example the ODBO standard, the JOLAP interface is defined in the Java environment. By contrast with SQL, interfaces are not so strongly standardized on this level.

If, for example, a database query is being made in accordance with ROLAP, or a simple database query is being made using SQL, for example, the processing of a database query can last a very long time in the event of a large database with a relatively complex structure. With a considerable time period up to the answering or data processing of a database query is very unpleasant for a user particularly when the result of the database query is that the specification of the database query was not sufficiently reasonable or was defective, or that no hits could be determined in the database with regard to the database query.

The problems presented above are to be explained in more detail with the aid of the following example:

A telecommunication company desires to select a suitable set of customers for an advertising campaign from its stored electronic customer database. For this purpose, the customer database of the telecommunication company is sent a database query that runs, for example, as follows:

“How many of the customers of the telecommunication company under the age of 18 years in Bavaria use a prepaid contract but nevertheless generate monthly more than 20 charge units?”

In accordance with the method explained above, the customer database is filtered for the appropriate customers in accordance with the database query, something which can last some time, in some cases minutes up to even hours, depending on the size of the database. In accordance with this example, it is assumed as a result of the database query that 800 customer data records correspond to the prescribed conditions in the database query. However, a dedicated advertising campaign is not sensible for this small set. Thus, the filter criteria are changed in the database query, and a renewed database query is started that, in turn, can last a few minutes up to even hours. This mode of procedure is usually continued iteratively until a hit set of desired size has been determined.

This makes it plain that the known technologies frequently lead to a multiplicity of time consuming iterations and considerably load both the database and the associated database management system (DBMS).

If many users simultaneously send similar database queries to the database, an additional considerable loading of the server computer(s) can occur owing to the repeated database queries, and this can lead to an additional lengthening of the response times to the database queries.

The invention is therefore based on the problem of providing a database query system and a method for computer-aided querying of a database in the case of which system and method the requisite time for processing database queries is reduced in the statistical sense.

The problem is solved by means of the database query system and by means of the method for computer-aided querying of a database having the features in accordance with the independent patent claims.

The database query system has at least one first device. A database is stored in the first device, the database containing a multiplicity of data. Furthermore, at least one second device is provided in which at least one compressed image of at least one portion of the contents of the database is stored. Furthermore, a query unit is provided that is coupled to the first device and to the second device and is set up in such a way that it can carry out querying of the contents of the compressed image and querying of the contents of the database.

The compressed image constitutes a content-compressed representation of the data stored in the database. A static image of the contents of the database is preferably used as compressed image; it is preferred, in particular, to use a statistical model of the contents of the database that is stored in the second device.

The query unit according to the invention opens up the possibility of not having to search the entire database for each database query, but of being able firstly to have recourse to the compressed image of the database and of firstly being able to query the compressed image. Even this first querying of the compressed image can lead to an approximate result that can already be sufficient for the respective database query, or can give adequate indications for a possible reformulation of the database query for use in querying the database itself.

The term database is to be understood in the scope of the invention in such a way that it can have any desired number of databases that can be distributed over any desired number of different computers with a multiplicity of associated different database management systems, and can also be a database with any desired number of database segments.

In this context, a statistical model is to be understood as any model that represents (exactly or approximately) all the statistical connections or the common frequency distribution of the data in a database, for example a Bayesian (or causal) network, a Markov network or generally a graphical probabilistic model, a latent variable model, a statistical clustering model or a trained artificial neural network. The statistical model can therefore be understood as a complete, exact or approximate, but compressed image of the statistics of the database.

In a method for computer-aided querying of a database that contains a multiplicity of data, a database query is formed—preferably by a client computer. After the database query has been sent to a query unit, a compressed image of the database that has previously been formed by using the database is queried in accordance with the database query. Depending on the result of the query of the querying of the compressed image, a check is made as to whether the result is sufficient with regard to the question posed, that is to say with regard to the database query or other prescribable criteria.

It is to be noted in this context that this checking can also be performed on the part of the client computer user in that the result of the querying of the compressed image is sent to the client computer, presented to the user there and checked by the user as to whether he has now obtained the desired information from the result. In a case when the user still requires more detailed information, an appropriate instruction is sent to the query unit. This instruction can consist in sending the query unit a message that more concrete information is required on the use of the original data query, whereupon the database is now queried in accordance with the original database query. Alternatively, a new database query can be formed and fed to the query unit, optionally together with the information to access the database itself directly, whereupon the compressed image and/or the database are/is queried in accordance with the new database.

The result of the querying of the compressed image and/or the result of the querying of the database are/is provided for further processing, for example sent to the client computer sending the database query.

Clearly, the invention can be seen in that a compressed image, preferably a statistical model, covering the data contained in a database, in other words covering the contents of the database, is formed, and the compressed image is installed as an entity between the database and client computer (on the business intelligence applications such as, for example, run by Business Objects). In the event of a database query, the compressed image is firstly queried in accordance with the database query, and an approximate result is thereby very quickly determined and provided to a user, something which may be already insufficient for the respective question posed in order to answer the database query. The approximate result frequently contains at least good indications of the direction and the prospects of success and the extent of an exact result of the database query.

The user is thereby yielded an instrument for efficiently fashioning database queries to databases with very large data volumes, something which leads to a considerable saving in requisite computing time, in the requisite data rate for transmitting the search results and, precisely for cost-related databases, to a considerable saving in costs in the course of database queries. If more concrete results are desired, the approximate results can finally be used as a basis to submit the database itself the same database query, or a changed one. In particular, complex database searches are thereby fashioned considerably more cost effectively.

Preferred refinements of the invention follow from the dependent claims.

The refinements described below relate both to the database query system and to the method for computer-aided querying of a database.

The database query system can have at least one client computer that is coupled to the query unit and is set up in such a way that it can undertake database requests or database queries.

In accordance with another refinement of the invention, it is provided that in addition to the statistical image of the contents of the database at least one portion of the data stored on the database is stored in compressed form in the second device.

The client computer(s) is/are usually coupled to the server computer and, thereby, to the database, via a telecommunication network, for example a telephone network, generally a Wide Area Network (WAN) or a local area network (LAN), and the communication via the communication network is preferably performed in accordance with the internet protocols Transport Control Protocol (TCP) and Internet Protocol (IP).

The query unit can be set up in accordance with the quasi standard open database connectivity (ODBC) or Java database connectivity (JDBC) for the purpose of communicating in the course of the actual database query (on OSI layer 7). Furthermore, the communication can also be performed via (proprietary) OLAP interfaces (ODBO, JOLAP).

The database queries are preferably formulated in accordance with the database query standard query language (SQL), in which case the query unit is set up in order to process database queries in accordance with SQL.

The database can have any desired number of databases, which can be distributed over a number of computers, the databases being coupled to the query unit.

In accordance with another embodiment of the invention, it is provided that the database or the databases has/have a plurality of database segments. Each database segment is in this case assigned a compressed image that has been formed over the respective database segment.

This embodiment of the invention has, in particular, the advantage that if during a database query over a respective compressed image of a database segment, it is highly likely for the respective database segment that no hits (or else only very few in an approximate procedure) are to be expected, a detailed database querying of the respective database segment (that is to say a complete search in the respective database segment) can be ruled out. Consequently, in the case when the database query is also carried out on the database itself, the database query is carried out only for the database segments that supply with sufficient likelihood results that correspond to the query criteria of the database query. A further advantage is that if the compressed image already contains sufficient information to generate a complete, exact result, it is possible in exactly the same way to rule out detailed database querying of the respective database segment (that is to say a complete search in the respective database segment). Thus, in summary, the only remaining need is to start a few additional detailed queries for a few segments.

This refinement of the invention can be provided in a corresponding way for the development that a number of databases are contained in the database query system. In this case, there is respectively formed for each database a compressed image of the respective database.

The query unit and the second device can be implemented jointly in a computer, preferably in a client computer.

The inventive use of a compressed image or a database renders it possible for the image, which has substantially smaller extent of data, preferably a few megabytes by comparison with a few gigabytes to terabytes of a complete database, to be transmitted in a simple way to the client computer via a conventional communication network.

If the compressed image is transmitted to the client computer, the first querying of the compressed image can be performed in order to determine an approximate query result without the need for a communication connection to the actual database. An offline operation of a client computer is also enabled in this way as long as an approximate result of the database query is sufficient.

In accordance with this refinement of the invention, an additional reduction in the requisite computing capacity of the server computer is further reached, and the bandwidth demand of the communication network for transmitting database queries and database query results is further reduced.

In an alternative embodiment, a second device can be provided in a dedicated computer independent of the client computer and of the server computer, and be coupled thereto via the communication network.

Furthermore, it can be indicated, preferably together with the query, in the server computer.

In accordance with another refinement of the invention, a decision unit is provided that checks whether the approximate result is sufficient in accordance with the prescribable quality criterion. In the case when the approximate result is not sufficient, the database query is automatically passed on to the database management system of the database itself, and the database querying of the complete database is thereby started.

In accordance with this refinement of the invention, the existence of a compressed image becomes transparent to the user, and the user friendliness is further enhanced, since the user need no longer be involved in the decision process as to whether the database itself is to be queried or not.

In another refinement of the invention, it is provided also to send with the database query information that specifies whether an exact result of the database query is desired, or whether an approximate result is also sufficient. If a fast, but approximate result is accepted in accordance with the information additionally specified in the database query, it is further possible to specify as quality criterion a statistical degree of reliability after which the result may be approximate, for example after which decimal place the approximation may have effects.

The server computer and the client computer(s) can be coupled to one another via any desired communication network, for example via a fixed network or via a mobile telephony network in order to transmit the respective data and to transmit the statistical model.

It is to be remarked that the statistical models can be formed by the server computers, and alternatively also by other computers that are possibly specifically set up therefor and are coupled to the databases. In this case, the statistical models formed are transmitted via the communication network to the respective query unit, which can be arranged in a dedicated computer, in the server computer or in one or each of the client computers.

It is thereby possible for the statistical models to be provided worldwide in a very simple way in a heterogeneous communication network, for example on the Internet.

At least one of the statistical models can be formed by means of a scaleable method with the aid of which the degree of compression of the statistical model can be set by comparison with the data elements contained in the respective database.

Furthermore, at least one of the statistical models can be formed by means of an EM learning method or by means of variants thereof or by means of a gradient-based learning method. For example, it is possible to use a so-called APN learning method (Adaptive Probabilistic Network learning method) can be used as a gradient-based learning method. In general, it is possible to use all the likelihood-based learning methods or Bayesian learning methods such as are described, for example, in [1].

The structure of the joint probability models can be specified here in the form of a graphical probabilistic model (a Bayesian network, a Markov network or a combination thereof). The so-called latent variable models or statistical clustering models correspond to a special case of this general formalism. Moreover, each method can be used for the purpose of learning not only the parameters, but also the structure of graphical probabilistic models from available data elements, for example any desired structured learning method as described, for example, in [2] and [3].

In addition to the statistical models, portions of the data can be stored with the models with varying resolution (for example a numerical value roughly represented by only one byte). It is preferred in this case to use the data statistics acquired by the model in order to represent the data in compressed fashion.

The more information is stored in the compressed image, the greater is the memory space requirement and the more complicated is the evaluation. There is thus the possibility of selecting a comprise, starting with a very small, approximate statistical model up to an already very detailed, exact image of the statistics of the contents of a database.

Exemplary embodiments of the invention are illustrated in the figures and will be explained in more detail below.

In the drawings:

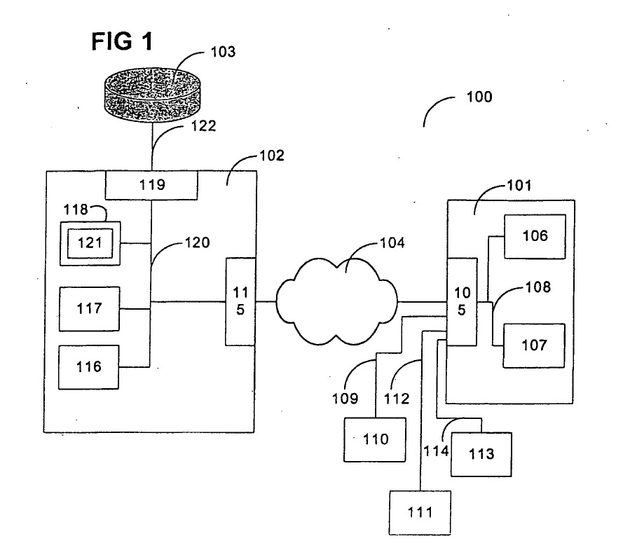

FIG. 1 shows a block diagram of a database query system in accordance with a first exemplary embodiment of the invention;

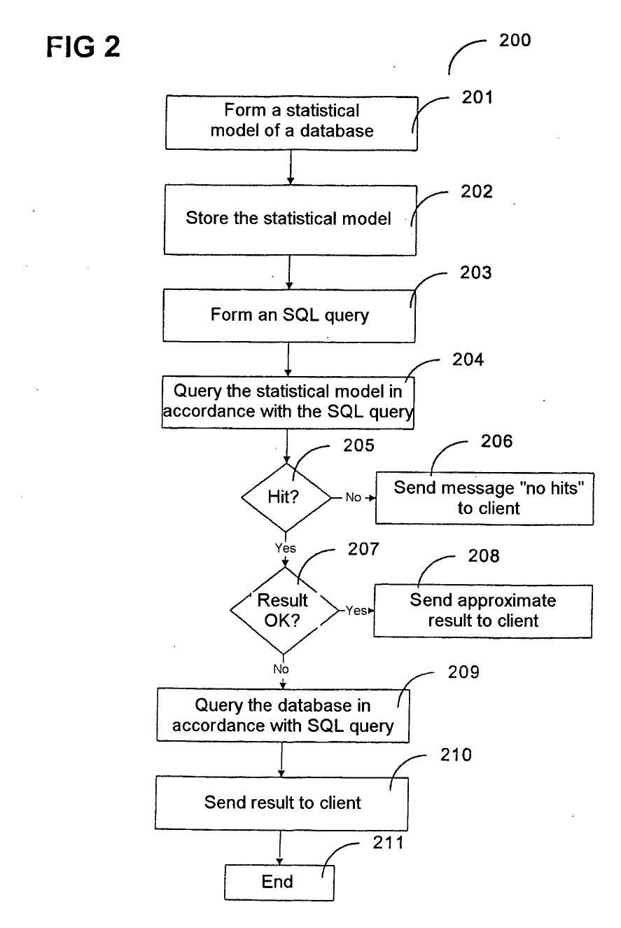

FIG. 2 shows a flowchart in which the individual steps of a processing of a database query in accordance with a first exemplary embodiment of the invention is demonstrated;

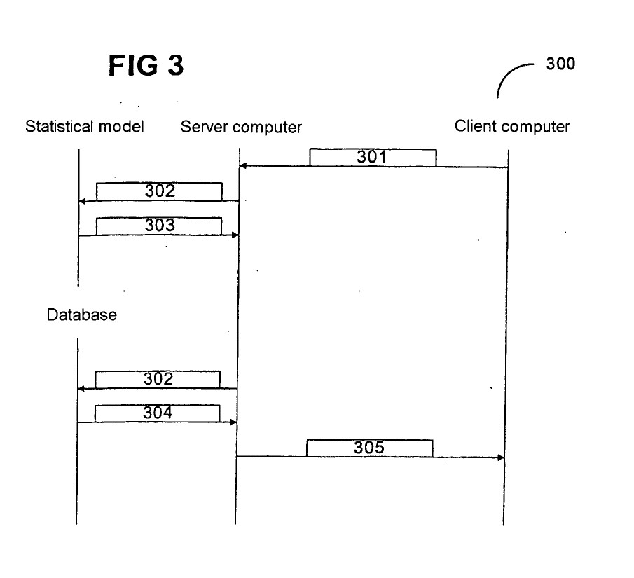

FIG. 3 shows a message flowchart in which the messages exchanged between a client computer and a server computer are illustrated in accordance with the first exemplary embodiment of the invention;

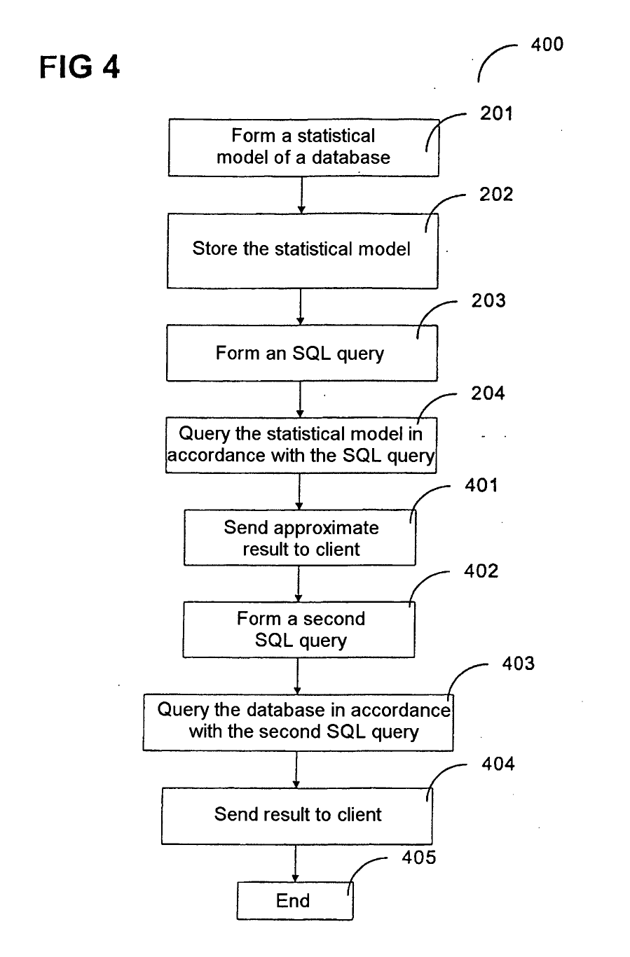

FIG. 4 shows a flowchart in which the individual steps of a processing of a database query in accordance with a second exemplary embodiment of the invention is demonstrated;

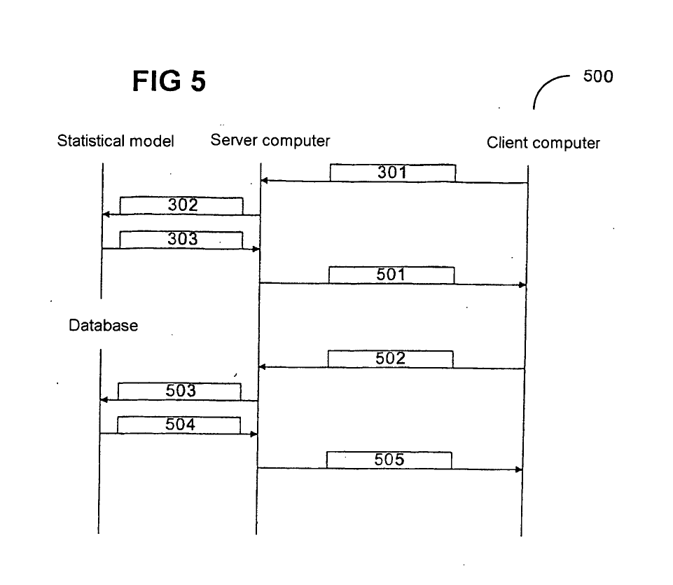

FIG. 5 shows a message flowchart in which the messages exchanged between a client computer and a server computer are illustrated in accordance with the second exemplary embodiment of the invention;

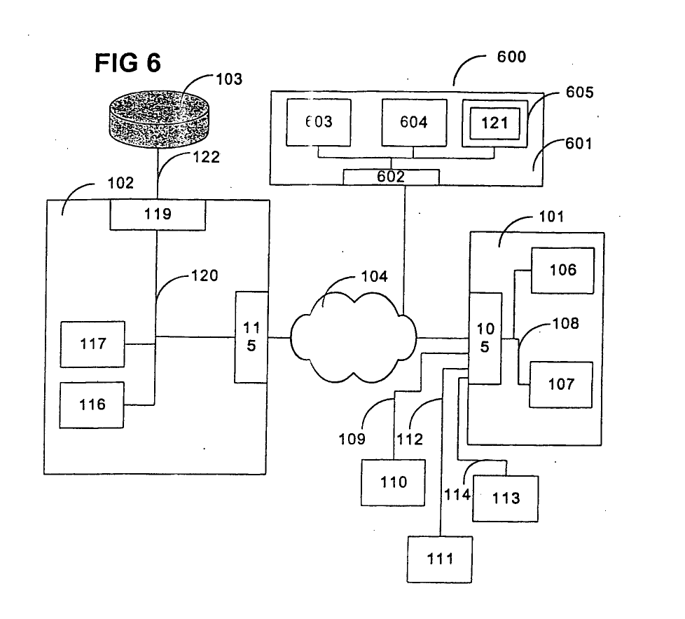

FIG. 6 shows a database query system in accordance with another exemplary embodiment of the invention; and

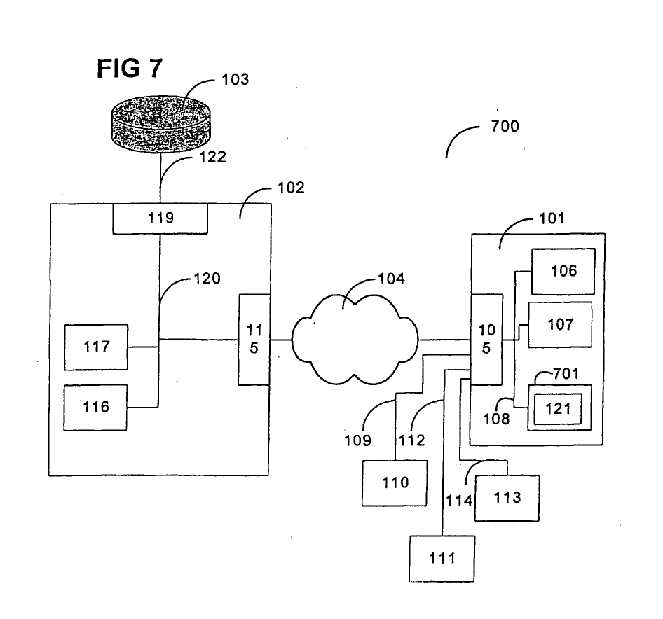

FIG. 7 shows a block diagram of the database query system in accordance with another exemplary embodiment of the invention.

Without restriction of the general validity, the database query systems according to the invention are described below with only one database and one client computer as well as one server computer. However, it is to be pointed out that it is fundamentally possible to provide any desired number of databases, any desired number of server computers and any desired number of client computers.

Identical or similar elements or method steps are provided in the figures with identical reference symbols.

FIG. 1 shows a database query system 100 in accordance with a first exemplary embodiment of the invention.

The database query system 100 has a client computer 101, a server computer 102 and a database 103.

The client computer 101 and the server computer 102 are coupled to one another via a telecommunication network 104, by means of the internet in accordance with one exemplary embodiment of the invention.

The client computer 101 has an input/output interface 105, a processor unit 106 and a memory unit 107. The input/output interface 105, the processor unit 106 and the memory unit 107 are coupled to one another via a computer bus 108.

The client computer 101 is coupled to the telecommunication network 104 by means of the input/output interface 105. Furthermore, via a first cable 109 of the first radio link (for example in accordance with Bluetooth) the client computer 101 is coupled to a display screen 110 for displaying data to a user. Furthermore, a keyboard 111 is coupled to an input/output interface 105 via a second cable 112 or a second radio link. Also provided is a computer mouse 113 that is coupled to the input/output interface 105 of the client computer 101 via a third cable 114 or via a third radio link.

The server computer 102 likewise has an input/output interface 115 that is coupled to the telecommunication network 104.

Furthermore there are provided in the server computer 102 a processor unit 116, a first memory unit 117, a second memory unit 118 and a database interface 119 that are coupled to one another and to the input/output interface 115 by means of a computer bus 120.

The programs that are carried out by the processor unit 116 are stored in the first memory unit 117.

The second memory unit 118, which serves as second device according to the invention, contains a statistical model 121, explained in more detail below, of the data stored in the database 103.

In accordance with this exemplary embodiment of the invention, the query unit is implemented in the form of a computer program that is stored in the first memory unit 117 and is carried out by the processor unit 116.

The server computer 102 is coupled to the database 103 via a database connection 122 by means of the database interface 119. A database management system (DBMS) (not illustrated) that can be implemented in the database 103 or in the server computer 102 is provided for the purpose of managing the database 103, in particular for controlling scanning and inputting of data from or into the database 103.

The server computer 102 and the client computer 101 are set up for communication in accordance with the internet communication protocols of Transport Control Protocol (TCP) and Internet Protocol (IP).

For the purpose of the actual processing of database queries, the server computer 102, the database 103 and the client computer 101 are set up in accordance with the ODBC standard for communication and, in the process of the formulation of the database query itself, in accordance with the standard query language standard (SQL standard).

The sequence of a database query is in the framework of the database query system 100 in accordance with the first exemplary embodiment of the invention is described below with reference to FIG. 2 and FIG. 3.

As is illustrated in a flowchart 200 in FIG. 2 a statistical model 121 of the data stored in the database 103 is formed in a first step (step 201) by the server computer 102.

In accordance with this exemplary embodiment of the invention, the statistical model 121 is formed by using the EM learning method known per se. Other alternative methods for forming the statistical model 121 that are preferred for use are described further in detail below.

In accordance with this exemplary embodiment of the invention, the statistical model 121 is formed anew automatically at regular, prescribable time intervals, based in each case on the most current data that are stored in the database 103.

The statistical model 121 is stored in the second memory unit 118 (step 202).

If a user of the client computer 101 would like to obtain information from the database 103, an SQL query is input into the client computer 101 (step 203) and transmitted from the client computer 101 to the server computer 102. It is possible for this purpose to install in the client computer 101 a browser computer program that cooperates with a web server program installed on the server side. Displayed for the user on the display screen 110 of the client computer 101 in this case is an HTML page together with a prompt to input database search criteria that the user would like to use to query a database 103.

The user has the possibility of formalizing the query directly in the database query language respectively to be used, or he can formulate a database query in normal language and/or by using keywords, in which case the database request is converted into an SQL database query by a conversion program provided.

The SQL query is embedded, in accordance with the communication protocol respectively used, in an SQL database query message 301 (compare message flowchart 300 in FIG. 3), and the SQL database query message 301 is transmitted to the server computer 102 from the client computer 101.

The server computer 102 queries the statistical model 121 in accordance with the SQL database query 302, that is to say it searches the statistical model 121 by using SQL database query 302. The approximate result is transmitted to the server computer 102 as SQL response 303 after a result relating to the SQL database query 302 and which represents an approximate result with regard to the total content of the database 103 has been determined for the statistical model 121.

The querying of the statistical model 121 in accordance with the SQL database query 302 is thereby completed (step 204).

Subsequently, by using the SQL response 303 the server computer 102 checks as to whether benefits at all are to be expected with regard to the SQL database query 302 in the event of a “full query” of the database 103 (step 205).

In this context, a hit is to be understood as a result of a database query in the case of which at least one data element of the database 103 that satisfies the query criteria specified in the SQL database query 302 is determined.

If, in accordance with the approximate SQL response 303 no hit is to be expected with sufficiently large likelihood given a complete query of the entire database 103, the server computer 102 sends a corresponding result message to the client computer 101 (not illustrated in FIG. 3) in which it is specified that no hits are to be expected in the case of a querying of the entire database 103 on the basis of the querying of the statistical model 121 (step 206).

If, however, it is established in step 205 that hits are to be expected with sufficient likelihood in the case of querying the entire database 103 (test step 207), the approximate, for example a specification of the number of likely hits in the database 103 is therefore sent in another result message to the client computer 101 (step 208).

It is provided in an alternative embodiment that in the case when it is determined in test step 205 that hits are to be expected in the database with sufficient likelihood, where as the approximate result is not sufficient with regard to the query criteria or prescribable quality criteria, the server computer 102 can therefore automatically transfer the SQL database query 302 to the database 103 and initiate a complete search of the entire database 103.

The result of the complete search is transferred as exact SQL query result 304 to the server computer 102, thus terminating the query of the database 103 in accordance with the SQL database query 302 (step 209).

Finally, the server computer 102 forms an SQL result message 305 in which the approximate and/or the exact result are/is contained. The SQL result message 305 is transferred from the server computer 102 to the client computer 101 (step 210).

The method is ended in a last method step (step 211).

FIG. 4 and FIG. 5 illustrate the individual method steps (flowchart 400 in FIG. 4) and the message flow (message flowchart 500 in FIG. 5) for the sequence of a database query in accordance with a second exemplary embodiment of the invention, this method being carried out by the structurally identical database query system as illustrated in FIG. 1.

For reasons of clear representation, only the differences from the procedure in accordance with FIG. 2 and FIG. 3 are explained below.

Steps 201, 202, 203 and 204 are identical to the procedure in accordance with the first exemplary embodiment.

By contrast with the preceding exemplary embodiment, however, after receipt of the approximate SQL response 303 the server computer 102 automatically forms an SQL response message 501, in which the approximate query result of the SQL database query 302 is contained, and sends it to the client computer 101 (step 401).

After receipt of the first SQL response message 501, in accordance with the specifications of the client computer 101 user, the client computer 101 forms a second SQL database query message 502, which contains a second SQL database query 503. The second SQL database query 503 can be identical to the first SQL database query 302 or be changed by comparison with the first SQL database query 302, preferably being given in concrete terms (step 402).

The second SQL database query message 502 is sent from the client computer 101 to the server computer 102, and the second SQL database query 503 is transferred there to the database 103, and a complete search is carried out in the entire database 103 (step 403) with the aid of the second SQL database query 503 contained in the second SQL database query message 502.

The result of the complete database query is transferred to the server computer 102 as exact SQL result 504, whereupon the server computer 102 forms an SQL response message 505 containing the exact SQL result 504 and sends it to the client computer 101 (step 404).

The method is ended (step 405) after the sending of the second SQL response message 505.

All the above described sequences and message flows are used in a corresponding way in alternative exemplary embodiments in the database query system 600 (compare FIG. 6) and 700 (compare FIG. 7), which systems have a changed computer architecture.

For this reason, in the context of the alternative database query systems 600 and 700 only their structure is explained, and no longer the individual method sequences for querying the database.

It is to be remarked in this context that in accordance with the message flowcharts 300 and 500 in FIG. 3 and FIG. 5, the entities of the statistical model 121 and of the database 103 are not limited to their actual local implementation as described in FIG. 1, for example.

In accordance with an alternative embodiment as illustrated in the database query system 600 in FIG. 6, the statistical model 121 can be implemented and stored in a dedicated computer 601, the computer 601 having an input/output interface 602 by means of which the computer 601 is coupled to the communication network 104. The computer 601 further has a processor unit 603 and a first memory unit 604 for storing the programs that are carried out by the processor unit 603, as well as a second memory unit 605, in which second memory unit 605 the statistical model 121 is stored.

The remaining elements of the database query system 600 are identical to those of the database query system 100 in accordance with FIG. 1, for which reason a more detailed explanation is dispensed with.

Clearly, this exemplary embodiment can be regarded as a distributed data query system 600 in the case of which the client computer 101 and the server computer 102 and the computer 601, in which the statistical models 121 are stored, are mutually independent computers that are coupled to one another by means of the communication network 104.

FIG. 7 shows a database query system 700 in accordance with a further refinement of the invention.

By contrast with the preceding exemplary embodiments, in accordance with this exemplary embodiment the statistical model 121 is respectively stored in a second memory unit 701 in the respective client computer 101.

This means that after the formation of the statistical model 121 the latter is respectively transmitted to the respective client computers 101.

In accordance with this refinement of the invention, it is rendered possible for the first database queries for determining an approximate result to be performed offline, that is to say without an activated communication link to a server computer 102.

This is enabled because the statistical model 121, compared usually with the entire database 103, has a considerably lesser extent and can therefore easily be transmitted by means of electronic post (e-mail) or by means of an appropriate communication protocol, for example the File Transfer Protocol (FTP) without requiring an excessively large bandwidth for the data transmission.

In order to achieve the aim of generating images of a database that are as small as possible and can therefore easily be exchanged electronically but are very accurate, scaleable learning methods that generate highly compressed images are desired, in particular, while at the same time the images are to fuse efficiently, that is to say be capable of being brought together efficiently, for which purpose it should be possible, in particular, to deal with missing information very efficiently, as well. Known learning methods are particularly slow when many of the occupancies of the fields are missing in the data.

Various scaleable methods for forming a statistical model are specified below.

A few fundamentals of the EM learning method will be explained in more detail for the purpose of better illustrating the improvement to the EM learning method that is preferably used in the case of a naïve Bayesian cluster model:

X={Xₖ, k=1, . . . , k} denotes a set of K statistical variables (which can, for example, correspond to the fields of a database).

The states of the variables are noted by small letters. The variable X₁ can assume the states x₁, ₁, x₁, ₂, . . . , that is to say X₁ε{x₁, ᵢ, i=1, . . . , L₁}. L₁ is the number of the states of the variable X₁. An entry in a data record (a database) consists of values for all the variables,

$${x}^{π} ≡ ( {x}_{1}^{π} , {x}_{2}^{π} , {x}_{3}^{π} , … )$$

denoting the π-th data record. In the π-th data record, the variable X₁ is in the state x₁^{π}, the variable X₂ is in the state

$${x}_{2}^{π} ,$$

etc. The table has M entries, that is to say {x^{π}, π=1, . . . , M}. In addition, there is a hidden variable or a cluster variable that is denoted below by Ω; its states are {ωᵢ, i=1, . . . , N}. There are thus N clusters.

In a statistical clustering model, P(Ω) describes an a priori distribution; P(ωᵢ) is the a priori weight of the i-th cluster, and P(X|ωᵢ) describes the structure of the i-th cluster, or the conditional distribution of the observable variables (contained in the database) X={Xₖ, k=1, . . . , K} in the i-th cluster. The a priori distribution and the conditional distributions for each cluster together parameterize a common probability model on X∪Ω or on X.

It is assumed in a naïve Bayesian network that p(X|ωᵢ) can factorize by

$${\prod }_{k = 1}^{K} p ( {X}_{k} \vert {ω}_{i} ) .$$

In general, the aim is to determine the parameters of the model, that is to say the a priori distribution p(Ω) and the conditional probability tables p(X|ω) in such a way that the common model reflects the input data as well as possible. A corresponding EM learning method consists of a row of iteration steps, an improvement to the model (for the purpose of a so-called likelihood) being achieved in each iteration step. New parameters p^{new}( . . . ) are estimated in each iteration step on the basis of the current or “old” parameters p^{old}( . . . ).

Each EM step firstly begins with the E step in which sufficient statistics are determined in tables provided therefor. A start is made with probability tables whose entries are initialized with zero values. The fields of the tables are filled in the course of the E step with the aid of the so-called sufficient statistics S(Ω) and S(X, Ω) by using expectation values to supplement the missing information for each data point (that is to say, in particular, the assignment of each data point to the clusters).

It is necessary to determine the a posteriori distribution p^{old},(wᵢ|x^{π})in order to calculate expectation values for the cluster variable Ω. This step is also denoted as “inference step”.

In the case of a naïve Bayesian network, the a posteriori distribution for Ω is to be calculated using the rule

$${p}^{old} ( {w}_{i} \vert {\underline{x}}^{π} ) = \frac{1}{{Z}^{π}} {p}^{old} ( {w}_{i} ) {\prod }_{k = 1}^{K} {p}^{old} ( {x}_{k}^{π} \vert {ω}_{i} ) \qquad ( 1 )$$

for each data point x^{π} from the information input,

$$\frac{1}{{Z}^{π}}$$

being a prescribable normalization constant.

The essence of this calculation consists in forming the product

$${p}^{old} ( {x}_{k}^{π} \vert {ω}_{i} )$$

over all k=1, . . . , K. This product must be formed in each E step for all the clusters i=1, . . . , N and for the data points x^{π}, π=1, . . . , M.

Similarly complicated and frequently even more complicated is the inference step for the assumption of other dependent structures as a naïve Bayesian network, and it therefore includes the essential numerical outlay on the EM learning.

The entries in the tables S(Ω) and S(X, Ω) change after the formation of the above product for each data point x^{π}, π=1, . . . , M, since S(ωᵢ) has p^{old}(ωᵢ|x^{π}) added to it for all i, or a sum of all p^{old}(ωᵢ|x^{π}) is formed. Correspondingly, S(x, ωᵢ) (or S(xₖ, ωᵢ) for all variables k in the case of a naïve Bayesian network) has p^{old}(ωᵢ|x^{π}) added to it in each case for all the clusters i. This initially terminates the E (expectation) step.

This step is used to calculate new parameters p^{new}(Ω) and p^{new}(x|Ω) for the statistical model, p(x|ωᵢ) representing the structure of the i-th cluster or the conditional distribution of the variables X, contained in the database, in this i-th cluster.

New parameters p^{new}(Ω) and p^{new}(x|Ω), which are based on the sufficient statistics already calculated, are formed in the M (maximization) step by optimizing a general log likelihood

$$L = {\sum }_{π = 1}^{M} log {\sum }_{i = 1}^{N} p ( {\underline{x}}^{π} \vert {ω}_{i} ) p ( {ω}_{i} ) \qquad ( 2 )$$

The M step is not attended by any further substantial numerical outlay.

It is therefore clear that the essential complexity of the algorithm rests in the inference step or on forming the product

$${\prod }_{k = 1}^{K} {p}^{old} ( {x}_{k}^{π} \vert {ω}_{i} )$$

and on the accumulation of the sufficient statistics.

The forming of numerous zero elements in the probability tables p^{old}(X|ωᵢ) and p^{old}(X_{K}|ωᵢ) can, however, be utilized by means of skillful data structures and storage of intermediate results from one EM step to the next in order to calculate the products efficiently.

In order to speed up the EM learning method, the forming of a total product in an inference step as above, which consists of factors of a posteriori distributions of membership probabilities for all the input data points is carried out as usual, but the formation of the total product is aborted as soon as the first zero occurs in the factors associated therewith. It may be shown that in a case when a cluster for a specific data point is assigned the weight zero in an EM learning process, this cluster is also assigned the weight of zero in all further EM steps for this data point.

A rational elimination of superfluous numerical outlay is thereby ensured by buffering appropriate results from one EM step to the next, and carrying out processing only for the clusters that do not have the weight of zero.

This thus results in the advantages that owing to the aborting of the processing when a cluster occurs with zero weights the EM learning method is significantly accelerated overall not only within an EM step but also for all the other steps, in particular during the formation of the product in the inference step.

In the method for determining a probability distribution which is present in predetermined data, membership probabilities for specific classes are calculated only up to a value of nearly 0 in an iterative method, and the classes with membership probabilities below a selectable value are no longer used in the iterative method.

In one development of the method, a sequence of factors to be calculated is determined in such a way that the factor which is associated with a rarely occurring state of a variable is processed first. The rarely occurring values can be stored in an ordered list before the start of the formation of the product in such a way that the variables are ordered in the list depending on the frequency of their appearance of a zero.

It is also advantageous to use a logarithmic representation of probability tables.

It is also advantageous to use a sparse representation of the probability tables, for example in the form of a list which contains only the elements which are different from zero.

In addition, when calculating sufficient statistics only the clusters which have a weight different from zero are taken into account.

The clusters which have a weight different from zero may be stored in a list, with the data which are stored in the list being able to be pointers to the corresponding clusters.

The method may also be an expectation maximization learning process in which, in the case of a cluster having an a posteriori weight of “zero” assigned to it for a data point, this cluster receives the weight zero in all the other steps of the EM method for this data point and this cluster no longer has to be taken into account in all the other steps.

The method may also run here only via clusters which have a weight which is different from zero.

I. First Example in an Inference Step

a) Formation of a Total Product With Interruption at the Zero Value

A total product is formed for each cluster ωᵢ in an inference step. As soon as the first zero occurs in the associated factors, which may be read out, for example, from a memory, array or a pointer list, the formation of the total product is aborted.

If a zero value occurs, the a posteriori weight which is associated with the cluster is then set to zero. Alternatively, it is also possible firstly to check whether at least one of the factors in the product is zero. In this context, all the multiplications for the formation of the total product are carried out only if all the factors are different from zero.

If, on the other hand, a zero value does not occur in a factor associated with the total product, the formation of the product is continued as normal and the next factor is read out from the memory, array or the pointer list and used to form the product.

b) Selection of a Suitable Sequence for Speeding Up the Data Processing

A skillful sequence is selected in such a way that if a factor in the product is zero it is very likely that this factor will occur very soon as one of the first factors in the product. As a result, the formation of the overall product can be aborted very soon. The new sequence may be defined here in accordance with the frequency with which the states of the variables occur in the data. A factor which is associated with a very rarely occurring state of a variable is processed first. The sequence in which the factors are processed can thus be defined once before the learning method starts by storing the values of the variables in a correspondingly ordered list.

c) Logarithmic Representation of the Tables

In order to limit as far as possible the computational outlay of the method mentioned above, a logarithmic representation of the tables is preferably used in order, for example, to avoid underflow problems. With this function it is possible to replace originally zero elements by a positive value, for example. As a result, complex processing or division of values which are nearly zero and differ from one another by only a small distance is no longer necessary.

d) Avoidance of Increased Summing When Calculating Sufficient Statistics

If the stochastic variables which are allocated to the learning method have a low membership probability in relation to a specific cluster, a large number of clusters will have the a posteriori weight of zero in the course of the learning method.

So that the accumulation of the sufficient statistics can also be speeded up in the subsequent step, only clusters which have a weight which is different from zero are then taken into account in this step.

It is advantageous here to store the clusters which are different from zero in a list, an array or a similar data structure which permits only the elements which are different from zero to be stored.

II. Second Example in an EM Learning Method

a) Clusters With Zero Assignments for a Data Point Are Not Taken Into Account

In particular, here information indicating which clusters are still permitted in the tables as a result of occurrence of zeros, and which are no longer permitted, is stored for each data point in an EM learning method from one step of the learning method to the next step.

Where clusters which are given an a posteriori weight of zero by multiplication by zero are excluded from all further calculations in the first example, in order to save numerical outlay, in in accordance with this example intermediate results relating to cluster memberships of individual data points (which clusters are already excluded or are still permissible) are also stored from one EM step to the next in additionally necessary data structures.

b) Storage of a List With References to Relevant Clusters

For each data point or for each input stochastic variable it is firstly possible to store a list or a similar data structure which contain references to the relevant clusters which have acquired a weight different from zero for this data point.

Overall, in this example only the permitted clusters are then stored, but for each data point in a data record.

The two examples above can be combined with one another, which permits the aborting when there are “zero” weights in the inference step, with only the permitted clusters still being taken into account according to the second example in the following EM steps.

A second variant of the EM learning method will be explained in more detail below. It is to be noted that this method is independent of the use of the statistical model which is formed in this way.

Referring to the EM learning method described above it is apparent that missing information does not have to be supplemented for all the variables. The invention has recognized that some of the missing information can be “ignored”. In other words, this means that no attempt is made to find out something about a random variable Y from data in which there is no information about the random variable Y (a node Y), or that no attempt is made to find out something about the relationships between two random variables Y and X (two nodes Y and X) from data in which there is no information about the random variables Y and X.

As a result, not only is the numerical outlay on carrying out the EM learning method substantially reduced, but it is also achieved that the EM learning method converges more quickly. An additional advantage can be considered to be the fact that statistical models can be more easily established in a dynamic fashion by means of this procedure, i.e. during the learning process it is more easily possible to supplement variables (nodes) in a network, the directional graph.

It is assumed, as a clear example of the method according to the invention, that a statistical model contains variables which describe which evaluation has been given to a film by a cinema goer. For each film there is a variable with each variable being assigned a plurality of states and with each state representing one evaluation value in each case. For each customer there is a data record in which information indicating which film has received which evaluation value is stored. If a new film is on offer, the evaluation values for this film are often missing at the beginning. By means of the new variant of the EM learning method there is now the possibility that until the new film appears the EM learning method is carried out only with the films which have been known until then, i.e. that the new film is firstly ignored (i.e. generally the new node in the directional graph). Only when the new film appears is a new variable (a new node) added dynamically to the statistical model and the evaluations of the new film taken into account. The convergence of the method in the sense of the log likelihood is still ensured here; the method even converges more quickly.

Below an explanation will be given of the conditions under which missing information does not need to be taken into account.

The following notation is used to explain the procedure. H denotes a concealed node. O={O¹, O², . . . , O^{M}} denotes a set of M observable nodes in the directional graph of the statistical model.

Without restricting the general applicability, a Bayesian probability model will be assumed below which can be factorized according to the following rule:

$$P ( H , \underline{O} ) = P ( H ) {\prod }_{π = 1}^{M} P ( {O}^{π} \vert H ) . \qquad ( 3 )$$

In this context it is to be noted that the described procedure can be applied to any statistical model and is not restricted to a Bayesian probability model, as will also be presented below in detail.

In the text which follows, random variables are denoted by upper case letters while an instance of a respective random variable is denoted by a lower case letter.

A data record with N data record elements {oᵢ, i=1, . . . , N} is assumed, with only some of the observable nodes being actually observed for each data record element. For the i-th data record element it is assumed that the node Xᵢ is observed and that the observation values of the node Yᵢ are missing.

The following therefore applies:
Xᵢ∪Yᵢ=Oᵢ. (4)

It is to be noted that a different record of nodes Xᵢ can be observed for each data record element, i.e. that the following applies:
Xᵢ≠Xⱼ for i≠j. (5)

The indices for existing nodes are denoted by κ, i.e. Xᵢ={Xᵢ^{κ}, κ=1, . . . , Kᵢ} and the indices for non-existing nodes are denoted by λ, i.e. Yᵢ={Yᵢ^{λ}, λ=1, . . . , L_{i}.}

In the case of a Bayesian network, the customary EM learning method has the following steps, as has already been presented above in brief:

1) E Step

The method is started with “empty” tables SS(H) and SS(O^{π},H), i=1, . . . , M (initialized with “zeros” in order to accumulate the estimations (sufficient statistics values) on this basis. The a posteriori distribution P(H|xᵢ) for the concealed nodes H and the a posteriori composite distribution P(H,Yᵢ^{π}|xᵢ) for each of the non-existing nodes Yᵢ together with the concealed node H are calculated for each data record element oᵢ.

The estimations for the statistical model are accumulated for each data record element i according to the following rules:

$$\begin{matrix}SS ( H ) += {\sum }_{i} P ( H \vert {\underline{x}}_{i} ) , & ( 6 ) \\ SS ( {X}_{i}^{κ} = {x}_{i}^{κ} , H ) += P ( H \vert {\underline{x}}_{i} ) , ∀ existing node {x}_{i}^{κ} , & ( 7 ) \\ SS ( {Y}_{i}^{λ} , H ) += P ( H , {Y}_{i}^{λ} \vert {\underline{x}}_{i} ) , ∀ non \text{-} existing node {Y}_{i}^{λ} . & ( 8 )\end{matrix}$$

The symbol += denotes the updating, i.e. the accumulation of the tables for the estimations according to the values of the respective “right-hand side” of the equation.

2) M Step

The parameters for all the nodes are updated in the M step according to the following rules:
P(H)∝SS(H), (9)
P(O^{π}|H)∝SS(O^{π},H), (10)
where the symbol ∝ indicates that the probability tables are to be normalized when transferring from SS to P.

According to the EM learning method the expected values are calculated for the non-existing nodes Yᵢ and updated for these nodes in accordance with the sufficient statistics values according to rule (7).

On the other hand, the calculation and updating of the composite distribution P(H,Yᵢ^{λ}|xᵢ) for all the nodes Yᵢ^{λ}εYᵢ requires a great computational effort. In addition, the updating of the composite distribution P(H,Yᵢ^{λ}|xᵢ) is a reason for the slow convergence of the EM learning method if a large portion of information is missing.

It will be assumed that the tables are initialized with random numbers before the EM learning method is started.

In this case, the composite distribution P(H,Yᵢ^{λ}|xᵢ) corresponds essentially to these random numbers in the first step. This means that the initial random numbers are taken into account in the sufficient statistics values according to the ratio of the missing information with reference to the existing information. This means that the initial random numbers in each table are “deleted” only in accordance with the ratio of the missing information with reference to the existing information.

In the text which follows it is proven that in the case of a Bayesian network as a statistical model the step according to rule (7) is not necessary and can thus be omitted or bypassed.

The log likelihood of the Bayesian network as a statistical model is given by:

$$L [ P ] = {\sum }_{i = 1}^{N} log P ( {\underline{x}}_{i} ) . \qquad ( 11 )$$

For freely prescribed tables B(H|Xᵢ), which are normalized with respect to the node H, the following is obtained for the log likelihood:

$$\begin{matrix}L [ P ] = {\sum }_{i = 1}^{N} B ( h \vert {\underline{x}}_{i} ) log P ( {\underline{x}}_{i} ) \\ = {\sum }_{i = 1}^{N} {\sum }_{h} B ( h \vert {\underline{x}}_{i} ) log \frac{P ( {\underline{x}}_{i} , h )}{P ( h \vert {\underline{x}}_{i} )} \\ = {\sum }_{i = 1}^{N} {\sum }_{h} B ( h \vert {\underline{x}}_{i} ) log P ( {\underline{x}}_{i} , h ) - {\sum }_{i = 1}^{N} {\sum }_{h} B ( h \vert {\underline{x}}_{i} ) log P ( h \vert {\underline{x}}_{i} )\end{matrix} \qquad ( 12 )$$

The sum

$${\sum }_{h}$$

designates the sum of all the states h of the node H.

Using the following definitions for R[P,B] and H[P,B]:

$$\begin{matrix}R [ P , B ] = {\sum }_{i = 1}^{N} {\sum }_{h} B ( h \vert {\underline{x}}_{i} ) log P ( {\underline{x}}_{i} , h ) & ( 13 ) \\ H [ P , B ] = {\sum }_{i = 1}^{N} {\sum }_{h} B ( h \vert {\underline{x}}_{i} ) log P ( h \vert {\underline{x}}_{i} ) & ( 14 )\end{matrix}$$

the following is obtained for the log likelihood according to rule (12):
L[P]=R[P,B]−H[P,B]. (15)

The following generally applies:
H[P,B]≦H[P,P], (16)
since H[P,P]−H[P,B] represents the nonnegative cross-entropy between P(h|xᵢ) and B(h|xᵢ).

In the t-th step, the current statistical model is denoted by P^{(t)}. A new statistical model P^{(t+1)} is constructed on the basis of the current statistical model P^{(t)} of the t-th step in such a way that the following applies:
R└P^{(t+1)},P^{(t)}┘>R└P^{(t)},P^{(t)}┘. (17)

The following applies:

$$\begin{matrix}L ⌊ {P}^{( t + 1 )} ⌋ = R ⌊ {P}^{( t + 1 )} , B ⌋ - H ⌊ {P}^{( t + 1 )} , B ⌋ \\ = R [ {P}^{( t + 1 )} , {P}^{( t )} ] - H [ {P}^{( t + 1 )} , {P}^{( t )} ] \\ > R [ {P}^{( t )} , {P}^{( t )} ] - H [ {P}^{( t )} , {P}^{( t )} ] \\ = L [ {P}^{( t )} ]\end{matrix} \qquad ( 18 )$$

The first line applies generally for all B (compare rule (15)). The second line of the rule (18) applies in particular to the case in which the following is true:
B=P^{(t)}. (19)

The third line applies owing to the rule (16). The last line of rule (18) corresponds in turn to rule (15).

The result of this is that for the case R[P^{(t+1)},P^{(t)}]>R[P^{(t)},P^{(t)}] the following definitely applies:
L[P^{(t+1)}]>L[P^{(t)}]. (20)

Reference is made to the difference from the standard EM learning method [2] in which the R term is defined according to the following rule:

$${R}^{Standard} [ P , B ] = {\sum }_{i = 1}^{N} {\sum }_{h , {\underline{y}}_{i}} B ( {\underline{y}}_{i} , h \vert {\underline{x}}_{i} ) log P ( {\underline{x}}_{i} , {\underline{y}}_{i} , h ) . \qquad ( 21 )$$

It is to be noted that in the argument of P and B in the above rule (21) the missing variables y also occur, in contrast to the definition corresponding to rules (13) and (14).

A sequence of EM iterations is formed in such a way that the following applies:
R^{Standard}[P^{(t+1)},P^{(t)}]>R^{Standard}[P^{(t)},P^{(t)}]. (22)

In the learning method according to the invention, a sequence of EM iterations is formed for the case of a Bayesian network in such a way that the following applies:
R[P^{(t+1)},P^{(t)}]>R[P^{(t)},P^{(t)}]. (23)

This shows that the to R, defined according to rule (13), leads to the learning method described above in which rule (8) is bypassed. In the case of a given current statistical model p^{(t)} for an iteration t, the aim of the method is to calculate a new statistical model P^{(t+1)} in the iteration t+1 by optimizing R|P,P^{(t)}| with respect to P. Using the factorization according to rule (3) yields the following:

$$\begin{matrix}R [ P , {P}^{( t )} ] = {\sum }_{i = 1}^{N} {\sum }_{h} {P}^{( t )} ( h \vert {\underline{x}}_{i} ) log P ( h ) + \\ {\sum }_{i = 1}^{N} {\sum }_{h} {\sum }_{κ = 1}^{{K}_{i}} {P}^{( t )} ( h \vert {\underline{x}}_{i} ) log P ( {x}_{i}^{κ} \vert h ) .\end{matrix} \qquad ( 24 )$$

Optimizing R with respect to the model P leads to the method according to the invention. The first term leads to the standard updating of P(H) according to rules (6) and (8).

By means of

$$SS ( h ) ≡ {\sum }_{i = 1}^{N} {P}^{( t )} ( h \vert {\underline{x}}_{i} ) log P ( h ) \qquad ( 25 )$$

the first term of rule (24) is obtained as

$${\sum }_{h} {\sum }_{i = 1}^{N} {P}^{( t )} ( h \vert {\underline{x}}_{i} ) log P ( h ) = {\sum }_{h} SS ( h ) log P ( h ) , \qquad ( 26 )$$

which corresponds essentially to the cross-entropy between SS(H) and P(H). The optimum P(H) is thus given by SS(H). This corresponds to the M step according to rule (9).

The second term of rule (24) leads to EM updating for the tables of the conditional probabilities P(O^{π}|H), as is described by means of the rules (7) and (10). In order to illustrate this, all the terms which are dependent on P(O^{π}|H) are collected in R. These terms are obtained according to the following rule:

$${\sum }_{h} {\sum }_{i = 1 \\ {O}^{π} ∈ {\underline{x}}_{i}}^{N} {P}^{( t )} ( h \vert {\underline{x}}_{i} ) log P ( {o}^{π} \vert h ) . \qquad ( 27 )$$

The sum

$${\sum }_{{i = 1}_{{O}^{π} ∈ {\underline{X}}_{i}}}^{N}$$

designates the sum of all the data elements i in the data record, with O^{π} being one of the observed nodes, i.e. at which the following applies:
O^{π}εXᵢ. (28)

In summary, the above expression (26) can be interpreted as the cross-entropy between P(O^{π}H) and the sufficient statistics values which are accumulated according to rule (7). It is thus not necessary to provide updating according to rule (8). This is due to the sum

$${\sum }_{{i = 1}_{{O}^{π} ∈ {\underline{X}}_{i}}}^{N}$$

in rule (27) or to the sum

$${\sum }_{κ = 1}^{{K}_{i}}$$

in rule (25). This sum takes into account only the observed nodes, in contrast to the definition of R^{Standard} according to rule (23) in which the non-observed nodes Yᵢ are not taken into account either.

The validity of the procedure for not taking into account non-observed nodes within the course of updating the sufficient statistics tables is presented below in a more generally valid case, which shows that the procedure is not restricted to a so-called Bayesian network.

A set of variables Z={Z¹, Z², . . . , Z^{M}} is assumed. It is also assumed that the statistical model can be factorized in the following way:

$$P ( \underline{Z} ) = {\prod }_{σ = 1}^{M} P ( {Z}^{σ} \vert Π [ {Z}^{σ} ] ) , \qquad ( 29 )$$

where Π[Z^{σ}] designates the “parent” nodes of the node Z^{σ} in the Bayesian network. In addition, a data record {zᵢ, i=1, . . . , N} with N data record elements is assumed for each node Z. As already assumed above, only some of the nodes Z are observed in each of the N data record elements in this case also. For the i-th data record element it is assumed that the nodes Xᵢ are observed; the nodes X̅ᵢ are not observed and the following applies:
Z=Xᵢ∪ X̅ᵢ. (30)

For each of the N data record elements, the non-observed nodes X̅ᵢ are divided into two subsets Hᵢ and Yᵢ in such a way that none of the nodes in the sets Xᵢ and Hᵢ is a dependent, i.e. successor node (“child” node) of a node in the set Yᵢ. This clearly means that Yᵢ corresponds to a branch in a Bayesian network for which there is no information in the data.

As a result, the composite distributions for the nodes Xᵢ and Hᵢ are obtained according to the following rule:

$$P ( {\underline{X}}_{i} , {\underline{H}}_{i} ) = {\prod }_{X ∈ {\underline{X}}_{i}} P ( X \vert \prod [ X ] ) {\prod }_{H ∈ {\underline{H}}_{i}} P ( H \vert \prod [ H ] ) . \qquad ( 31 )$$

1) E Step

For each node Z, tables

$$SS ( Z , \prod [ Z ] )$$

which are initialized with zero values are formed or made available. For each data record element i in the data record, the a posteriori distribution

$$P ( Z , \prod [ Z ] \vert {\underline{X}}_{i} = {\underline{x}}_{i} )$$

are calculated and the sufficient statistics values are accumulated according to the following rule for each node Z ε Xᵢ and ZεHᵢ:

$$SS ( Z , \prod \vert Z ) += P ( Z , \prod [ Z ] \vert {\underline{X}}_{i} = {\underline{x}}_{i} ) . \qquad ( 32 )$$

The sufficient statistics values of the tables which are assigned to the nodes in X̅ᵢ are not updated.

2) M Step

The parameters (tables) of all the nodes are updated according to the following rule:

$$P ( {Z}^{σ} \vert \prod [ {Z}^{σ} ] ) α SS ( {Z}^{σ} , \prod [ {Z}^{σ} ] ) . \qquad ( 33 )$$

The invention can clearly be considered as providing a wide and easy (but in general approximated) access to the statistics of a database (preferably over the Internet) through the formation of statistical models for the contents of the database. In addition to the models, it is possible to store some of the data with the models in compressed form in order to obtain a more accurate access to details of the statistics of the contents of the database. As a result, the statistical models are automatically dispatched for “remote diagnosis”, for so-called “remote assistance” or for “remote research” via a communication network. In other words “knowledge” in the form of a statistical model is communicated and dispatched. Knowledge is frequently knowledge about the relationships and mutual dependencies in a domain, for example about the dependencies in a process. A statistical model of a domain which is formed from the data of the database is an image of all these relationships. In technical terms, the models constitute a common probability distribution of the dimensions of the database and are therefore not restricted to a specific functional definition but rather constitute any desired dependencies between the dimensions. When compressed to form the statistical model, the knowledge about a domain can be very easily handled, dispatched, made available to any desired users etc.

The resolution of the image or of the statistical model can be selected in accordance with the requirements of data protection or the requirements of the parties involved.

The following publications are cited in this document:
[1] Radford M. Neal and Geoffrey E. Hinton, A View of the EM Algorithm that Justifies Incremental, Sparse and Other Variants, M. I. Jordan (Editor), Learning in Graphical Models, Kulwer, 1998, pages 355-371
[2] D Heckermann, Bayesian Networks for Data Mining, Data Mining and Knowledge Discovery, pages 79-119, 1997
[3] Reimar Hofmann, Lernen der Struktur nichtlinearer Abhängigkeiten mit graphischen Modellen [Learning the structure of nonlinear dependencies with the aid of graphical models], Dissertation an der Technischen Universität München, [Dissertation at the Technical University of Munich], Verlag: dissertation.de, ISBN: 3-89825-131-4

1. A database query system, having
at least one first device that has stored a database, the database containing a multiplicity of data,
at least one second device that stores a compressed image of at least one portion of the contents of the database, and
a query unit that is coupled to the first device and to the second device and is set up in such a way that it can carry out querying of the contents of the compressed image and querying of the contents of the database.

2. The database query system as claimed in claim 1, in which a statistical image is stored in the second device as a compressed image.

3. The database query system as claimed in claim 2, in which a statistical model is stored in the second device as the statistical image.

4. The database query system as claimed in claim 2 or 3, in which in addition at least one portion of the data stored in the database is stored in compressed form in the second device.

5. The database query system as claimed in one of claims 1 to 4, having at least one client computer that is coupled to the query unit and is set up in such a way that it undertakes database requests or database queries.

6. The database query system as claimed in one of claims 1 to 5, in which the query unit is set up for communicating in accordance with open database connectivity or java database connectivity.

7. The database query system as claimed in one of claims 1 to 6, in which the query unit is set up for processing database queries in accordance with Standard Query Language or in accordance with known OLAP interfaces (ODBO).

8. The database query system as claimed in one of claims 1 to 7, having a plurality of databases that are coupled to the query unit.

9. The database query system as claimed in one of claims 1 to 8, in which the database has a plurality of database segments, and in which a compressed image is provided for each database segment.

10. The database query system as claimed in one of claims 5 to 9, in which the second device is implemented in the client computer.

11. The database query system as claimed in one of claims 1 to 9, in which the first device and the second device are implemented jointly in a computer.

12. A method for computer-aided querying of a database that contains a multiplicity of data,
in which a database query is formed,
in which the compressed image of the database is queried in accordance with the database query,
in which it is checked independently of the result of the query of the compressed image whether the result is sufficient,
in which the database is queried in accordance with the database query or in accordance with another database query in the case when the result is not sufficient, and
in which the result of the query of the compressed image and/or the result of the query of the database are/is provided.
